(19) United States
(12) Patent Application Publication
(10) Pub. No.: US 2003/0017608 A1
(43) Pub. Date: Jan. 23, 2003

(54) Method and device for the indentification of molecules present in a carrier liquid

(76) Inventor: Dieter Sewald, Au/SG (CH)

Correspondence Address: LERNER AND GREENBERG,P.A., Post Office Box 2480, Hollywood, FL, 33022-2480, US

(21) Appl. No.: 10/200,705

(22) Filed: Jul. 22, 2002

Related U.S. Application Data
(63) Continuation of application No. PCT/EP01/00583, filed on Jan. 19, 2001.

(30) Foreign Application Priority Data
Jan. 21, 2000 (DE) 100 02 597.8

(51) Int. Cl. G01N 27/00

(52) U.S. Cl. 436/150; 422/82.01; 436/34

(57) ABSTRACT

A method and a device identify molecules present in a carrier liquid. The carrier liquid is located in a container configuration that is provided with two electrodes, these electrodes being connected to a source of electrical high-frequency energy whose frequency can be modified through a wide range. The molecules can be identified by their absorption resonance frequency.

### CROSS-REFERENCE TO RELATED APPLICATION

This application is a continuation of copending International Application No. PCT/EP01/00583, filed Jan. 19, 2001, which designated the United States and was not published in English.

### BACKGROUND OF THE INVENTION

### FILED OF THE INVENTION

The present invention relates to a method and a device for the identification of molecules that are present in a carrier liquid, wherein the carrier liquid is located in a container configuration that is provided with two electrodes.

In the chemical and pharmaceutical industry, there will be a great future demand to draw conclusions about the analysis and synthesis of organic substances quickly and on an industrial scale. Such conclusions may be limited merely to the presence of particular substances in a carrier liquid, or they may provide information about the level of the yield, or the progress as a function of time, of a reaction between molecules.

Biosensors, in which the evaluation of electronic and physical quantities are employed as indicators in order to obtain the desired information, also seem to be very promising for this. In terms of process engineering, this may involve utilizing matricial configurations of microelectronically integrated sensors, which are used as an interface between the organic substances and various electronic measurement methods.

Because this topic is related to two very different scientific disciplines, microelectronic measurement techniques in particular may still hold considerable potential for innovation.

Measurement methods based on the change of a classical electrical quantity are usually proposed for this kind of biosensor technology according to the prior art.

The following are some examples.

### Change in the Flow of Current Through an Interdigitated Electrode Structure with the Reaction Time of Molecules

Problem: It is necessary to measure currents in the nA range, which are provided for different measurements with very different offset currents. This entails stringent requirements on the sensitivity of the system, and a strong effect of an organic reaction on the quantity to be measured is hence necessarily required.

Furthermore, this method is unsuitable for situations where there is ambiguity. Hence, it cannot be used for a mixture of molecules that is capable of more than just one specific reaction. In each case, it is only possible to evaluate the flow of current, but not whether molecule A has reacted with molecule B or whether molecule A has reacted with molecule C.

### Change in the Conductance or the Active and Reactive Impedances at a Bioelectronic Interface with the Reaction Time of Molecules

Problem: This measurement method also has only a limited dynamic range, since the effect of a biochemical reaction on the measurement signal cannot be chosen to be arbitrarily large. Reactions must likewise take place with a well-defined scheme, because even this measurement method scarcely provides usable information for ambiguous reactions.

### Measurement of a Capacitance Change at a Bioelectronic Interface

Problem: The stray capacitances of an electrode structure may be of the same order as the capacitance change to be evaluated. This limits the use of these methods in terms of sensitivity here. The restriction to unambiguous reactions also applies here.

### SUMMARY OF THE INVENTION

It is accordingly an object of the invention to provide a method and device for the identification of molecules that are present in a carrier liquid that overcome the hereinafore-mentioned disadvantages of the heretofore-known devices of this general type and that identify molecules that are present in a carrier liquid and have substantially higher sensitivity.

With the foregoing and other objects in view, there is provided, in accordance with the invention, a method for the identification of molecules in a carrier liquid. The first step of the method is providing a container configuration having two electrodes. The next step is placing the carrier liquid into the container configuration. The next step is applying electrical radio-frequency energy whose frequency is varied over a wide range to the electrodes. The next step is determining an absorption resonant frequency within the wide range of electrical radio-frequency energy for the molecules. The next step is identifying the molecules based on the absorption resonant frequency.

With the objects of the invention in view, there is also provided a device for identifying molecules in a carrier liquid. In the device, a container configuration holds the carrier liquid. The device also includes a tunable radio-frequency oscillator and an evaluation circuit. Two electrodes are disposed in the container and connect to the tunable radio-frequency oscillator and the evaluation circuit.

According to the invention, this object is achieved by a method wherein electrical radio-frequency energy whose frequency is varied over a wide range is applied to the electrodes, and the molecules are identified on the basis of their absorption resonant frequency.

Preferably, the amount of the identified molecules may in this case also be determined based on the strength of the absorption.

A favorable possibility is in this case to determine the absorption by transmission measurement.

It is likewise possible to determine the absorption by reflection measurement.

The phase information may also be evaluated.

The preferred carrier liquid is distilled water, because it has a very high resonant frequency of 22 GHz, which is very far away from the resonant frequencies of the molecules to be identified.

Particularly favorably, the absorption may be determined with the S parameter values.

In order to monitor the progress of a reaction as a function of time, it is particularly preferred according to the invention for the reaction to take place in the carrier liquid in the container configuration, and for the progress as a function of time to be ascertained based on the time variation of the resonance spectra.

In order to establish the result of a reaction, it is particularly preferred according to the invention for the evaluation of the resonance spectra to be used to establish how high the yield is for the reaction product, what residual fraction of the original reaction partners is left over, and whether additional unwanted reaction products have been formed.

Preferably, a plurality of measurements may be conducted in parallel on various samples as a time division multiplex.

Preferably, the container configuration and the electrodes may be produced in CMOS technology. The entire circuit, including the electronic components, can in this way be integrated particularly well on a single chip.

It is in this case particularly preferred for the radio-frequency signals measured at the electrodes of the container configuration to be sent to a mixer circuit for lowering the frequency prior to further processing. Lower frequencies can then be processed with correspondingly less difficulty.

The object according to the invention is also achieved by a device in which the electrodes are connected to a tunable radio-frequency oscillator and an evaluation circuit.

It is in this case particularly preferred for a mixer circuit for lowering the frequency to be disposed between the electrodes and the evaluation circuit. In this way, the further processing at a lower frequency level is considerably simplified.

Preferably, the evaluation circuit includes an A/D converter and a computation unit.

A signal processor or microcontroller may in this case preferably be used as the computation unit.

Preferably, the device may be constructed from a matricial integrated configuration of a plurality of containers. A plurality of measurements can thereby be carried out in parallel.

The preferred technology for producing the device according to the invention is CMOS technology.

Other features which are considered as characteristic for the invention are set forth in the appended claims.

Although the invention is illustrated and described herein as embodied in a method and device for the identification of molecules that are present in a carrier liquid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram representing a radio-frequency spectroscopy method according to the invention;

FIG. 2 is a partial diagrammatic and partial block view showing the principle of the S parameter method;

FIG. 3 is spectrogram plotting reflection and transmission versus frequency;

FIG. 4 is a spectrogram showing an example of molecular resonances before a reaction;

FIG. 5 is a spectrogram showing molecular resonances during the course of the reaction;

FIG. 6 is a spectrogram showing the molecular resonances toward the end of the reaction; and

FIG. 7 is a partial diagrammatic and partial schematic view showing a measurement cell according to the invention and the associated signal processing.

### DESCRIPTION OF THE PREFERRED EMBODIMENTS

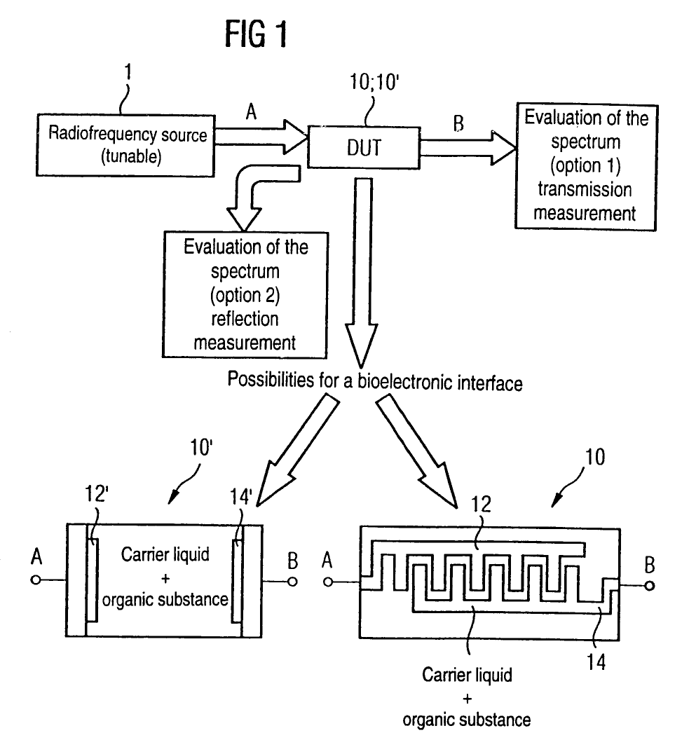

Referring now to the figures of the drawings in detail and first, particularly to FIG. 1 thereof, there is shown the functional principle of the present invention. In a radio-frequency spectroscopy method, a radio-frequency source 1 generates power at a low level while its tuning is scanned over as wide a frequency range as possible for a measurement cycle.

A suitable “device under test” (DUT) is a container configuration that is filled with carrier liquid and is provided with two electrodes, which are dimensioned in such a way that power can be transmitted from terminal A to terminal B with the least possible loss under the given conditions. Distilled water (H₂0), for example, may be one such carrier liquid because its molecule size is correspondingly small.

If the DUT is provided with radio-frequency energy, then, as a function of the size of the molecules that are located in a container, absorption resonances are to be expected within an observed frequency range. The mechanism behind this is based on the absorption of radio-frequency energy by the molecules at particular resonant frequencies. In the case of water, for example, this frequency lies at about 22 GHz, as disclosed by Skolnik, Introduction to Radar Systems, 1980, McGraw-Hill. The radio-frequency power of this particular frequency sets the water molecules in rotation, so that it is converted into heat. This power is consumed in the DUT, and it is therefore neither reflected nor transmitted.

In contrast to this, organic substances are composed of comparatively large molecules (for example DNA, hemoglobin, etc.). In comparison with the water molecule, a molecular resonance will therefore occur at very much lower frequencies, so that it cannot at all be overshadowed by the resonance of this carrier liquid. The type and position of a resonance depend, of course, on factors such as the molecule size, polarity of the molecule, and bonding to the carrier liquid. Therefore, the resonance is substance-specific.

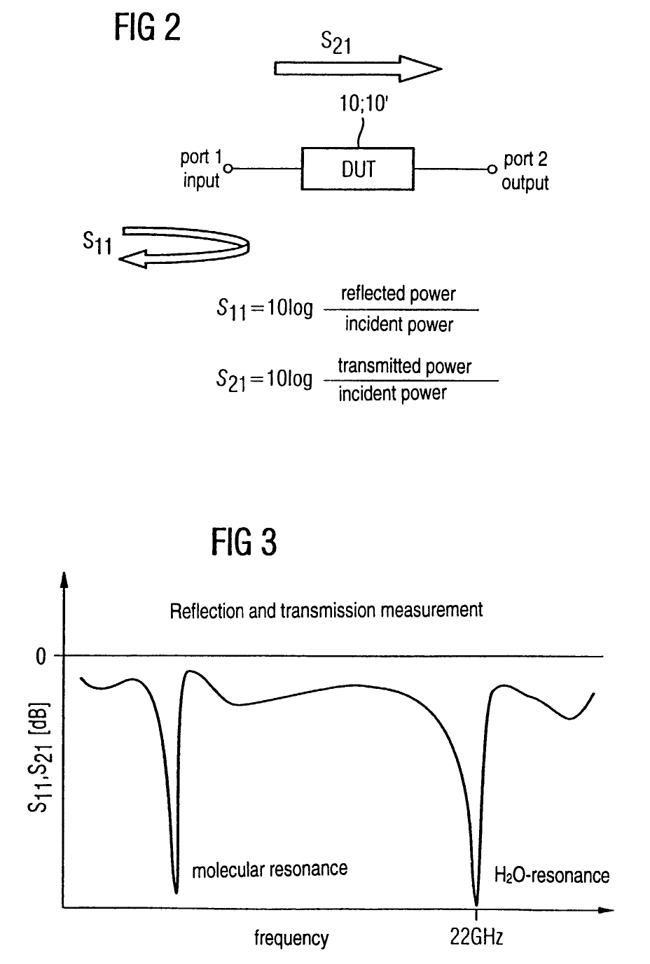

The method according to the invention can be operated in two modes, as transmission measurement and as reflection measurement. The former situation involves measuring the power transmitted by the DUT within a frequency range. This will be correspondingly lower for the case of molecular resonances. The latter situation involves recording the power reflected by the DUT, which is likewise a minimum in the case of resonance because a large part of the power is absorbed by the molecules. In addition to the amplitude of the power level, it is also possible to evaluate the phase information. The quantities for power observation in classical radio-frequency measurement techniques are predominantly the S parameters (see FIG. 2 for definition). Reference thereto is therefore made in FIG. 3.

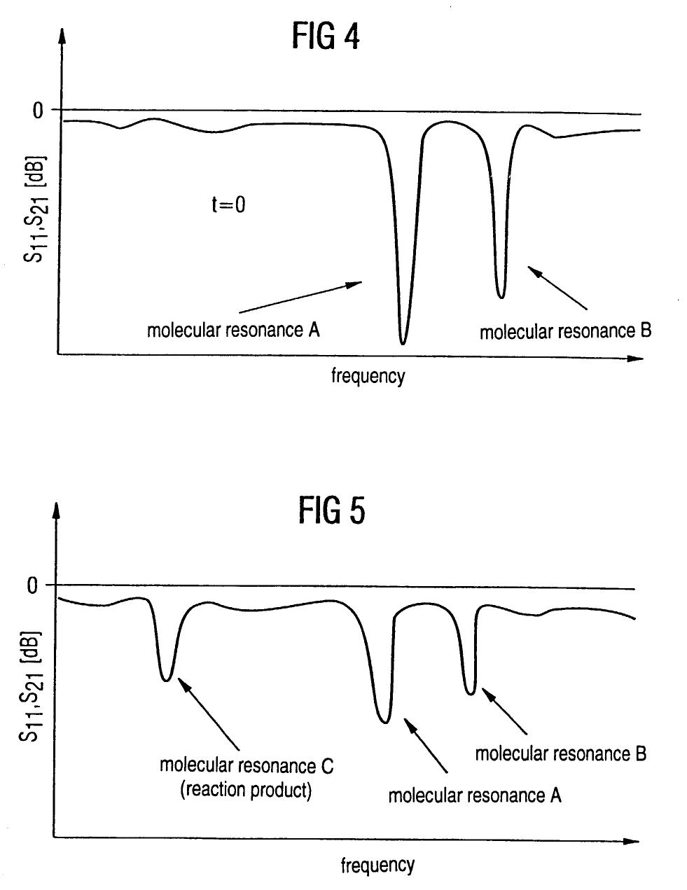

FIGS. 4 to 6 are intended to describe a conceivable measurement scenario for the progress as a function of time of a reaction between two molecules A and B.

At time t=0, there are two substances with different molecular composition in the DUT, and no reaction has taken place yet (FIG. 4). Molecule A has a stronger resonance than molecule B, and it hence appears to be present in a higher concentration.

In the course of the reaction, the concentration of both substances decreases, and the reaction product is formed. This, of course, has a higher molecular weight than the starting materials, so that its spectral resonance lies at a lower frequency, as represented in FIG. 5.

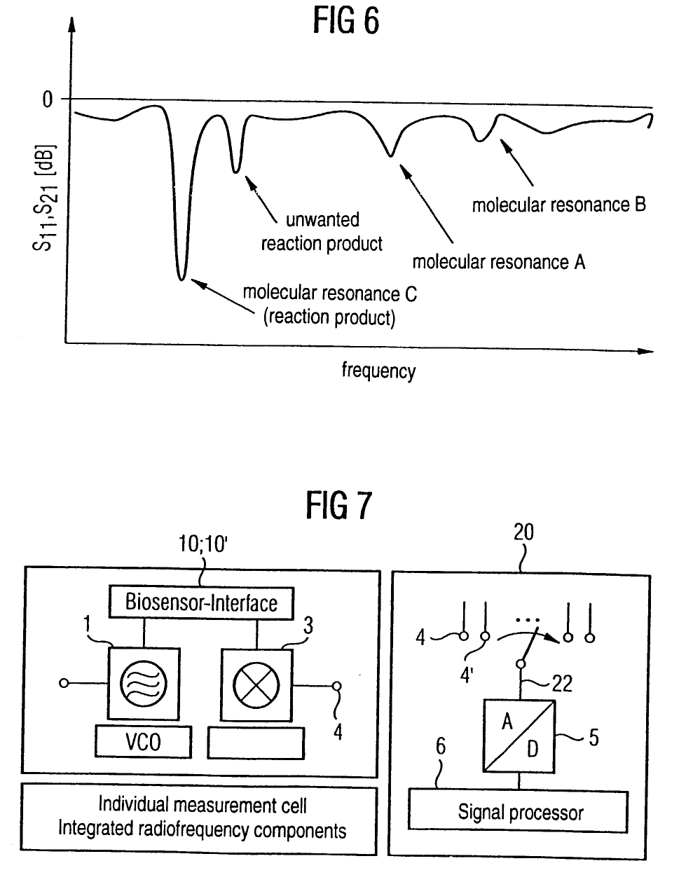

After the reaction has concluded (FIG. 6), the spectral plot can be used to ascertain how high the yield for molecule C is, what residual fraction of molecules A and B is left over, and whether additional unwanted reaction products have been formed.

The duration of such a biochemical reaction is generally orders of magnitude longer than the time required for a measurement cycle (ms range). It is feasible to carry out a plurality of measurements on various samples in parallel.

One decisive advantage of the method according to the invention, in comparison with the known principle, is that it has a very large dynamic range since, as is known, levels can be measured over several decades (LOG scale: dB) using the radio-frequency measurement technique. The biosensor hence has a correspondingly high sensitivity. In addition, this type of measurement technique provides the possibility of resolving different substances, that is to say being able to assign resonances in the spectrum to several substances.

Especially for a microelectronic embodiment of this method, transmission measurement is preferable because the sample containers can have very small dimensions. Moreover, better results may be expected from this type of measurement.

So that evaluations can be made in a short time and in an industrial fashion, a matricially integrated configuration of sample containers is conceivable. One possible structure of an individual cell, as represented in FIG. 7, includes a broadband-tunable VCO 1 (voltage-controlled oscillator) as the radio-frequency source, a biosensor-technology interface 10 or 10′, for example as shown in detail in FIG. 1, and a mixer circuit 3 that carries out a frequency conversion of the measured radio-frequency signal to lower more easily processable frequencies. This ensures that all the radio-frequency components and power feeds are integrated, which keeps the outlay and costs low. Owing to the ever-improving radio-frequency properties of new process generations, this configuration could be produced in CMOS technology.

The signals of the individual cells could be recorded in parallel, or using multiplex operation, and digitized by an A/D converter 5. A computer unit 6 (signal processor, microcontroller) processes the signals, calculates the spectrum from the time data and manages the driving of the individual cells.

As represented in FIG. 1, the corresponding container configuration that contains the carrier liquid and the molecules to be studied is referred to as the “device under test” (DUT) 10; 10′. This DUT 10; 10′ receives radio-frequency energy from a tunable radio-frequency source 1, for example a voltage-controlled oscillator. In this case, it is possible to carry out either a transmission measurement (referred to as Option 1) or a reflection measurement (referred to as Option 2). Depending on the technology and on the concentration of the carrier liquid, either a container configuration according to 10′ may be chosen, in which one electrode 12′; 14′ is located on each of the two end faces in a cuboid or cylindrical container, and the carrier liquid and the organic substances are disposed in-between, or a flat configuration of the electrodes may be chosen as in the container configuration 10, in which the two electrodes 12, 14 engage with one another like combs and the carrier liquid, with the organic substances contained in it, covers these comb-like structures.

The corresponding radio-frequency measurement method is represented in FIG. 2. Optionally, in reflection measurement, the radio-frequency power reflected at the input of the DUT 10; 10′ may be divided by the incident power. The measurement value for the corresponding absorption spectrum is in this case preferably represented as the base-10 logarithm of this ratio, so that the formula represented in FIG. 2 as S11 is obtained.

A simpler metrological treatment is usually obtained when the power transmitted by the DUT 10; 10′ is expressed in proportion to the incident power. Here again, the spectra are represented as the base-10 logarithm of this ratio, so that the formula represented in FIG. 2 for S₂₁ is obtained.

FIG. 3 shows an example representation of such a spectroscopic measurement. Interestingly, the results for reflection measurement and transmission measurement, according to the layouts of the corresponding electrodes, are essentially similar, because the corresponding resonances at the respective frequencies lead both to a reduction in the reflected power and to a reduction in the transmitted power. The resonance for the carrier liquid water at 22 GHz, as well as a molecular resonance lying at a substantially lower frequency, can be seen clearly. The represented curve is obtained when only one molecule type is present in the carrier liquid water.

In practical application, the method according to the invention and the device according to the invention are, however, usually employed to monitor a reaction. The resonance curves represented in FIGS. 4 to 6 are then obtained. FIGS. 4 to 6 represent only lower frequencies, so that the resonance of the carrier liquid water is no longer depicted.

The initial state of a reaction at time t=0 is represented in FIG. 4. The two molecular resonances A and B of the two reaction partners A and B are clearly visible.

FIG. 5 shows the state during the course of the reaction. The molecular resonances for the molecules A and B have decreased in the intervening time, because these molecules have been partially consumed by the reaction. On the other hand, a new molecular resonance C is found at a considerably lower frequency. This is the molecular resonance of the reaction product C. In this case, it is then assumed that a reaction is taking place in which the molecules A and B are essentially combined to form a larger molecule C.

FIG. 6 shows the final state after the reaction has concluded. The molecular resonances A and B are greatly reduced because these molecules have essentially been used up by the reaction. The molecular resonance C, which represents the reaction product, is now very highly pronounced. Besides this, a further weaker resonance is also to be seen, at a somewhat higher frequency. This demonstrates that an unwanted reaction product with a smaller molecular size has also been formed.

Lastly, FIG. 7 shows the structure as it may be chosen for a technically usable embodiment of the invention. In this case, the individual measurement cell represented on the left-hand side of FIG. 7 will be described first. It includes a voltage-controlled oscillator 1, which generates the required radio-frequency energy and feeds it to the DUT 10; 10′. This is referred to here as the biosensor interface. The structure of this biosensor interface may be constructed according to the two embodiments of FIG. 1.

The output of the biosensor interface 10; 10′ is here connected to a radio-frequency mixer 3, by which the frequency is lowered and fed to an output terminal 4.

All the components of such an individual cell may be integrated on a chip in CMOS technology. Furthermore, a plurality of such individual cells may be integrated in a single configuration on a chip. The individual outputs 4 of the individual measurement cells are then fed to a multiplexer 22, which connects the individual outputs 4, 4′ etc. to an analog/digital converter 5 that, in turn, is connected to a signal processor 6. The circuit components may also be integrated on the chip.

CMOS technology is most suitable for the integration on the chip.

I claim:

1. A method for identifying molecules in a carrier liquid, which comprises:
providing a container configuration having two electrodes;
placing the carrier liquid into the container configuration;
applying electrical radio-frequency energy varied over a wide range of frequencies to the electrodes;
determining an absorption resonant frequency within the wide range for the molecules; and
identifying the molecules based on the absorption resonant frequency.

2. The method according to claim 1, which further comprises:
measuring absorption at the absorption resonant frequency; and
determining an amount of the molecules based on the absorption.

3. The method according to claim 2, wherein the measuring of the absorption is determined by transmission measurement.

4. The method according to claim 2, wherein the measuring of the absorption is determined by reflection measurement.

5. The method according to claim 1, which further comprises:
measuring phase information over the wide range of frequencies of the electrical radio-frequency energy; and
evaluating the phase information.

6. The method according to claim 1, which further comprises using distilled water as the carrier liquid.

7. The method according to claim 2, wherein the measuring of the absorption at the absorption resonant frequency uses S parameter values.

8. A method for monitoring progress of a reaction as a function of time, which comprises:
providing a container configuration having two electrodes;
placing the carrier liquid into the container configuration;
conducting the reaction in the carrier liquid in the container configuration;
applying electrical radio-frequency energy varied over a wide range of frequencies to the electrodes;
measuring resonance spectra in the wide range of electrical radio-frequency over time; and
comparing the resonance spectra over the time.

9. The method according to claims 8, which further comprises:
combining reaction partners to form a product in the reaction; and
evaluating the spectra to establish a yield of the product, residual fractions of the reaction partners, and a presence of byproducts.

10. The method according to claim 1, which further comprises:
providing a plurality of samples; and
making a plurality of measurements in parallel on the plurality of samples as a time division multiplex.

11. The method according to claim 1, which further comprises producing the container configuration and the electrodes in CMOS technology.

12. The method according to claims 1, which further comprises lowering the frequencies of the radio-frequency signals measured at the electrodes of the container configuration by using a mixer circuit before further processing.

13. A device for identifying molecules in a carrier liquid, comprising:
a container configuration for holding the carrier liquid;
a tunable radio-frequency oscillator;
an evaluation circuit;
two electrodes disposed in said container configuration and connected to said tunable radio-frequency oscillator and said evaluation circuit.

14. The device according to claim 13, further comprising a mixer circuit for lowering frequencies received by said electrodes and disposed between said electrodes and said evaluation circuit.

15. The device according to claim 13, wherein said evaluation circuit has an A/D converter and a computation unit.

16. The device according to claim 15, wherein said computation unit is a signal processor.

17. The device according to claim 15, wherein said computation unit is a microcontroller.

18. The device according to claim 13, further comprising a matricial integrated configuration including said container configuration and at least further container configuration.

19. The device according to claim 13, wherein said container configuration and said electrodes are constructed in CMOS technology.
